(19) United States
(12) Patent Application Publication
(10) Pub. No.: US 2001/0020290 A1
(43) Pub. Date: Sep. 6, 2001

(54) METHOD AND SYSTEM FOR ROBUST DISTRIBUTED CIRCUIT SYNTHESIS

(75) Inventors: WILLIAM K LAM, FREMONT, CA (US); LIANG CHEN, SARATOGA, CA (US)

Correspondence Address: FINNEGAN HENDERSON FARABOW GARRETT AND, DUNNER, 1300 I STREET NW, WASHINGTON, DC, 200053315

(73) Assignee: SUN MICROSYSTEMS, INC., PALO ALTO, CA (US)

(21) Appl. No.: 09/100,463

(22) Filed: Jun. 19, 1998

(51) Int. Cl. G06F 9/45; G06F 17/50

(52) U.S. Cl. 716/7; 716/18

(57) ABSTRACT

Based upon a circuit design, a system generates a plurality of subdesigns. An initial circuit constraint is used to generate a plurality of constraints, one for each subdesign. The plurality of subdesigns and the corresponding constraints are distributed to a plurality of processors. In parallel, the processors execute a design software application to generate a plurality of candidate circuits based on the constraints and the subdesigns. The best candidate of the plurality of candidate circuits may be used for additional iterations in the design process.

### BACKGROUND OF THE INVENTION

A. Field of the Invention

This invention relates generally to circuit design and, more particularly, to improved methods and apparatus for robust distributed circuit synthesis.

B. Description of the Related Art

Design synthesis is a process of creating an integrated circuit implementation from a functional specification and a set of constraints. In recent years, integrated circuits have become increasingly complex and typically incorporate one to five million logic gates. Integrated circuits are implemented using technologies less than 0.25 micron in size mounted on a flat physical surface. The physical implementation of an integrated circuit is often referred to as a “chip.”

Today, integrated circuits are often designed using logic synthesis software such as Synopsis Design Compiler offered by Synopsys, Inc. Before using logic synthesis software programs, like Design Compiler, chip designers decide what functions the chip should perform and compile a functionality specification. Most conventional synthesis software programs use the functionality specification to test candidate circuit architectures. The functionality specification and various parameters, or “constraints,” are input to the synthesis software. Examples of constraints are the desired size of the circuit (in physical area) or the circuit speed in performing the functions specified in the functionality specification. Synthesis software programs use the functionality specification and constraints to produce a circuit design. The runtime required for synthesis software programs to produce a circuit design varies greatly depending on such factors as the speed of the processor on which the software program is operating, the complexity of the circuit design, and the difficulty of building a circuit that satisfies the specified functions and constraints. It is not uncommon, however, for a synthesis software program to take days, even weeks, to run to completion.

One difficulty encountered in circuit design is that often the constraints are not precisely known at the start of the design period or may change during the design period. Sometimes, determining constraints is a part of the design process and requires a process of trial and error. During a trial and error process, the circuit designer begins with constraints that may be chosen randomly. The synthesis software is run using these constraints and the circuit designer manually evaluates the output. The circuit designer then refines the constraints and runs the synthesis software again.

Results from synthesis software can be very sensitive and a small change in the constraints may cause drastically different synthesis outcomes. It is necessary, therefore, to repeat this process numerous times to achieve the final circuit design. Sometimes the design process requires going back to a previous result and trying a different refinement or using a previous set of constraints with some modifications. If each iteration of a large, complex circuit design takes a few days to complete, the total time for circuit design becomes quite lengthy. Therefore, a need exists for improving the design of circuits in parallel.

### SUMMARY OF THE INVENTION

In accordance with the invention, a method of generating a circuit comprises the steps of (a) receiving a circuit design; (b) receiving an initial circuit constraint; (c) generating a plurality of subdesigns based on the circuit design; (d) generating a plurality of constraints based on the initial circuit constraint, each constraint corresponding to a subdesign; (e) distributing each subdesign and corresponding constraint to one of a plurality of processors; and (f) generating, in parallel, a plurality of candidate circuits based on the plurality of subdesigns and constraints.

In accordance with another aspect of the present invention, an apparatus for generating a circuit comprises a memory storing program instructions, and a processor configured according to the program instructions to perform the steps of (a) receiving a circuit design; (b) receiving an initial circuit constraint; (c) generating a plurality of subdesigns based on the circuit design; (d) generating a plurality of constraints based on the initial circuit constraint, each constraint corresponding to a subdesign; (e) distributing each subdesign and corresponding constraint to one of a plurality of processors; and (f) generating, in parallel, a plurality of candidate circuits based on the plurality of subdesigns and constraints.

In still another aspect of the present invention, a computer-readable medium comprises (a) a component configured to obtain a circuit design; (b) a component configured to obtain an initial circuit constraint; (c) a component configured to generate a plurality of subdesigns based on the circuit design; (e) a component configured to distribute each subdesign and corresponding constraint to one of a plurality of processors; and (f) a component configured to generate, in parallel, a plurality of candidate circuits based on the plurality of subdesigns and constraints.

In accordance with yet another aspect of the present invention, a system for generating a circuit comprises (a) means for receiving a circuit design; (b) means for receiving an initial circuit constraint; (c) means for generating a plurality of subdesigns based on the circuit design; (d) means for generating a plurality of constraints based on the initial circuit constraint, each constraint corresponding to a subdesign; (e) means for distributing each subdesign and corresponding constraint to one of a plurality of processors; and (f) means for generating, in parallel, a plurality of candidate circuits based on one of the plurality of subdesigns and constraints.

### BRIEF DESCRIPTION OF THE DRAWINGS

The accompanying drawings, which are incorporated in and constitute a part of this specification, illustrate an embodiment of the invention and, together with the description, serve to explain the advantages and principles of the invention. In the drawings,

FIG. 1 is a block diagram of a computer system in which systems consistent with the present invention may be implemented;

FIG. 2 is a block diagram of a system consistent with the present invention;

FIGS. 3a and 3b are a flow diagram representing steps of a method for designing a circuit consistent with the present invention;

FIG. 4 is a flow diagram showing a basic circuit; and

FIG. 5 shows a basic circuit with multiple paths through point x.

### DETAILED DESCRIPTION

Reference will now be made in detail to an implementation of the present invention as illustrated in the accompanying drawings. Wherever possible, the same reference numbers will be used throughout the drawings and the following description to refer to the same or like parts.

A. Overview

Systems and methods consistent with the present invention may allow the circuit designer to synthesize a circuit design in parallel. A circuit design is divided into a set of subdesigns and distributed to a network of computers. From an initial constraint set, a family of constraint sets corresponding to the subdesigns is generated. Synthesis jobs comprising a subdesign and a constraint set are dispatched to a network of computers and synthesized simultaneously. The plurality of synthesis results are used for the next iteration of circuit design.

B. Architecture

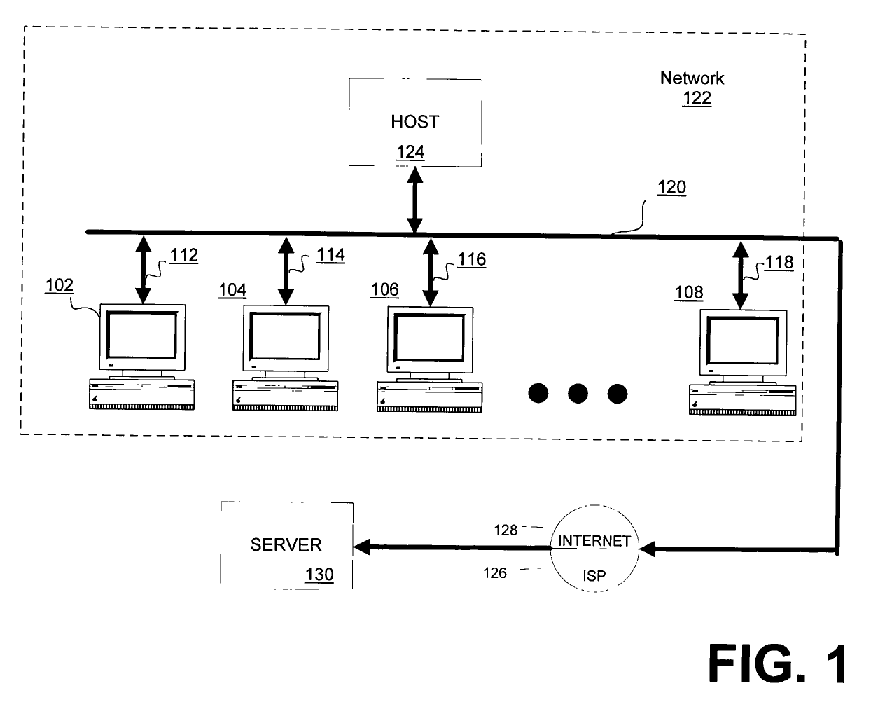

Methods and systems consistent with the present invention operate in distributed systems comprised of, for example, multiple homogenous or heterogenous machines operationally connected to form a network. An exemplary network for use with the present invention is shown in FIG. 1 and is designated by reference number 122. Network 122 comprises one or more clients 102, 104, 106, 108 operatively connected to network link 120 by communication interfaces 112, 114, 116, and 118. In addition, network 122 includes a host 124 linked to network link 120.

Network link 120 typically provides data communication between one or more of clients 102, 104, 106, and 108 and host 124 to data devices outside of network 122. For example, network link 120 may provide a connection through network 122 to data equipment operated by an Internet Service Provider (ISP) 126. ISP 126 in turn provides data communication services through the Internet 128 to server 130. Network 122 and Internet 128 may use any one of electric, electromagnetic, or optical signals to carry digital data streams. The signals through the various networks and the signals on network link 120 are exemplary forms of carrier waves transporting the information.

Clients 102, 104, 106, and 108 can send and receive data, including program code, through network link 120 and communication interfaces 112, 114, 116, and 118 to host 124 and server 130. For example, server 130 transmits a request for an application program through Internet 128, ISP 126, and network 122 to client 102, 104, 106, or 108 or host 124. In accordance with one implementation, an application consistent with the present invention may be downloaded to client 102, 104, 106, or 108. The received code may be executed by a processor as it is received, and/or stored in storage device 210, or other non-volatile storage for later execution. Application code in this form is one example of a carrier wave.

Although clients 102, 104, 106, and 108 are shown in FIG. 1 as being connectable to one server 130, clients 102, 104, 106, and 108 may establish connections to multiple hosts and server on Internet 128. In addition, fewer or more clients may be used.

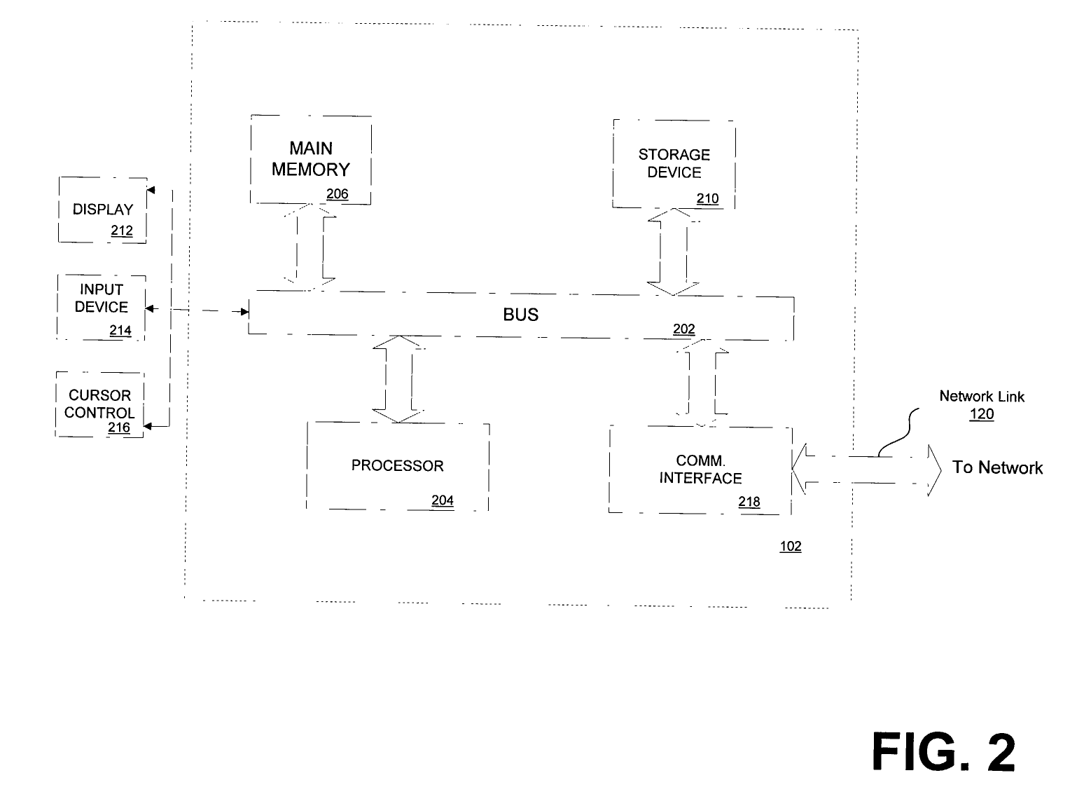

FIG. 2 illustrates systems suitable for use with the present invention. Clients 102, 104, 106, 108, and host 124 are conventional computers as shown in FIG. 2. For ease of explanation, however, the system in FIG. 2 is referred to only as client 102. Client 102 comprises a bus 202 and a processor 204 coupled to bus 202 for processing information and executing application programs. Client 102 also comprises a main memory, such as a random access memory (RAM) 206 or other dynamic storage device, coupled to bus 202 for storing information and instructions to be executed by processor 204. RAM 206 also may be used for storing temporary variables or other intermediate information during execution of instructions to be executed by processor 204. Client 102 further comprises a read only memory (ROM) 208 or other static storage device coupled to bus 202 for storing static information and instructions for processor 204. A storage device 210, such as a magnetic disk or optical disk, is provided and coupled to bus 202 for storing information and instructions.

Client 102 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Methods and systems consistent with the present invention may operate in a distributed environment as shown in FIG. 1. Consistent with one implementation, processor 204 of client 102, 104, 106, or 108 executes one or more sequences of one or more instructions contained in main memory 206. These instructions may include, for example, the steps of the program code associated with a circuit synthesis software program consistent with the present invention. Such instructions may be read into main memory 206 from another computer-readable medium, such as storage device 210. Execution of the sequences of instructions contained in main memory 206 causes processor 204 to perform the process steps described herein. In an alternative implementation, hard-wired circuitry may be used in place of or in combination with software instructions to implement the invention. Thus implementations of the invention are not limited to any specific combination of hardware circuitry and software.

The term “computer-readable medium” as used herein refers to any media that participates in providing instructions to processor 204 for execution. Such a medium may take many forms, including but not limited to non-volatile media, volatile media, and transmission media. Non-volatile media includes, for example, optical or magnetic disks, such as storage device 210. Volatile media includes dynamic memory, such as main memory 206. Transmission media includes coaxial cables, copper wire, and fiber optics, including the wires that comprise bus 202. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, a carrier wave, or any other medium from which a computer can read.

Various forms of computer-readable media may be involved in carrying one or more sequences of one or more instructions to processor 204 for execution. For example, the instructions may initially be carried on magnetic disk of a remote computer. The remote computer can load the instructions into its dynamic memory and send the instructions over a telephone line using a modem. A modem local to client 102 can receive the data on the telephone line and use an infra-red transmitter to convert the data to an infra-red signal. An infra-red detector coupled to bus 202 can receive the data carried in the infra-red signal and place the data on bus 202. Bus 202 carries the data to main memory 206, from which processor 204 retrieves and executes the instructions. The instructions received by main memory 206 may optionally be stored on storage device 210 either before or after execution by processor 204.

Client 102 also comprises a communication interface 218 coupled to bus 202. Communication interface 218 provides a two-way data communication coupling to a network link connects client 102 to a network, such as network 122 shown in FIG. 1. For example, communication interface 218 may be an integrated services digital network (ISDN) card, cable modem, or a modem to provide a data communication connection to a corresponding type of telephone line. As another example, communication interface 218 may be a local area network (LAN) card that provides a data communication connection to a compatible LAN. Wireless links may also be implemented. In any such implementation, communication interface 218 sends and receives electrical, electromagnetic or optical signals that carry digital data streams representing various types of information.

C. Method

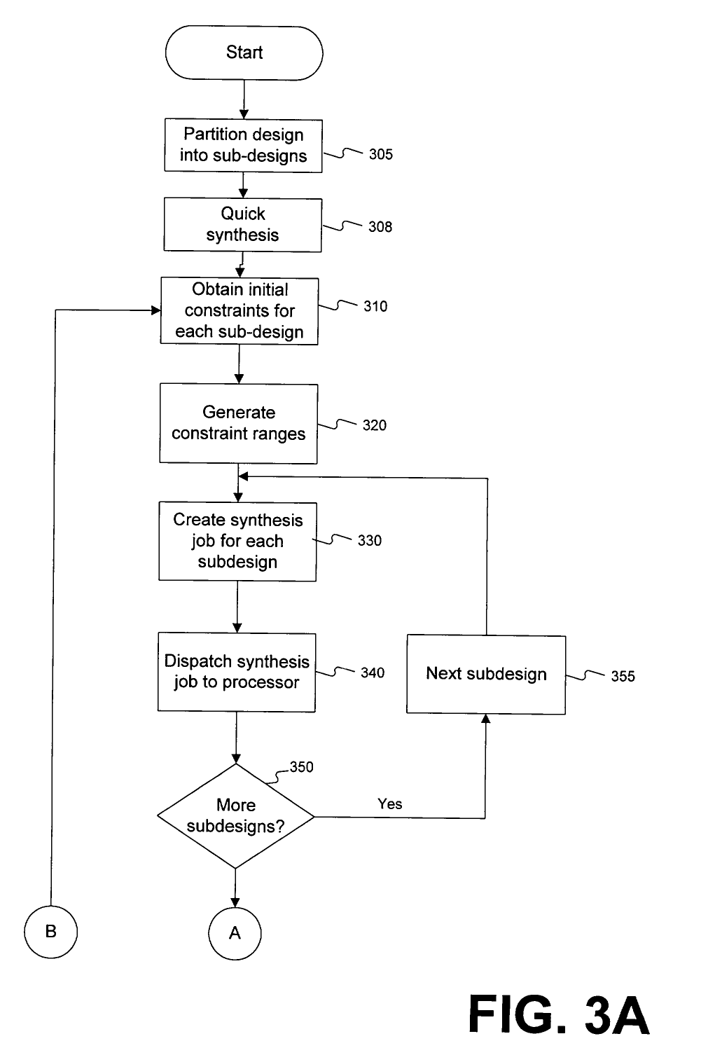

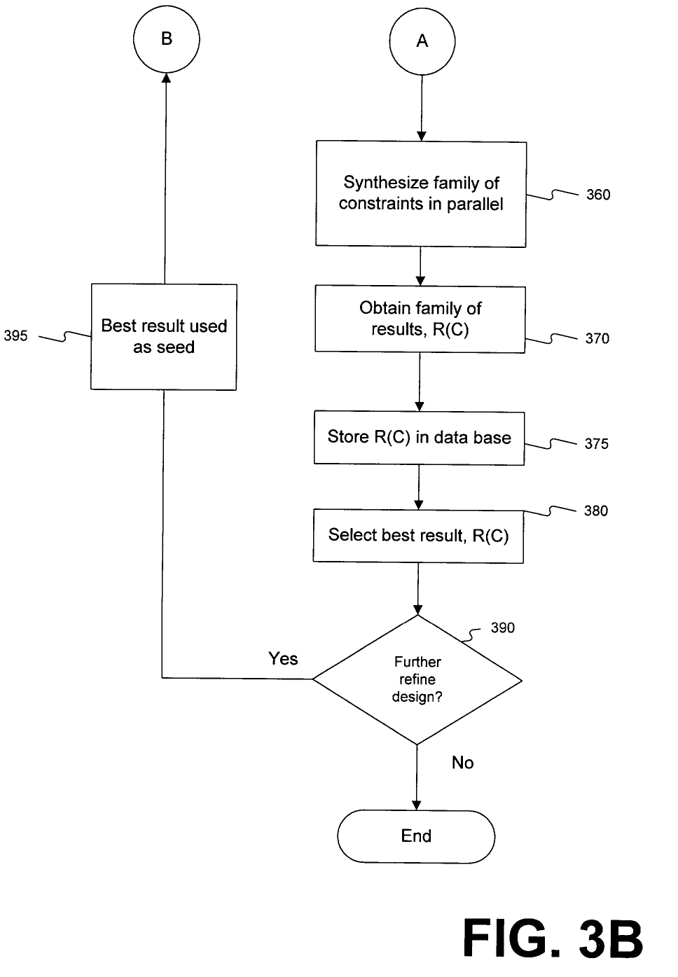

FIGS. 3a and 3b are flowcharts showing steps of a method consistent with the present invention. To begin, a design D is partitioned into a set of N subdesigns comprising the set {Dᵢ} (step 305). A subdesign is a portion of design D that represents a definable operational unit smaller than the entire circuit represented by design D. For example, if the desired circuit is simply a chain of buffers, a subdesign Dᵢ may be a single buffer. In more complex circuit designs, a subdesign may represent a collection of modules. Design D may be partitioned manually by the circuit designer or partitioned automatically by running synthesis software.

The total circuit design, D, may be submitted to the synthesis software and run without using constraints (step 308). The process of running synthesis software without restraints is often referred to as “quick-synthesis.” Synthesis software programs run without constraints typically produce a result in a very short period of time. The synthesis job on the total circuit design produces an initial representation of a circuit showing a connection of gates. Path lengths calculated for an initial representation may be used to calculate initial constraints.

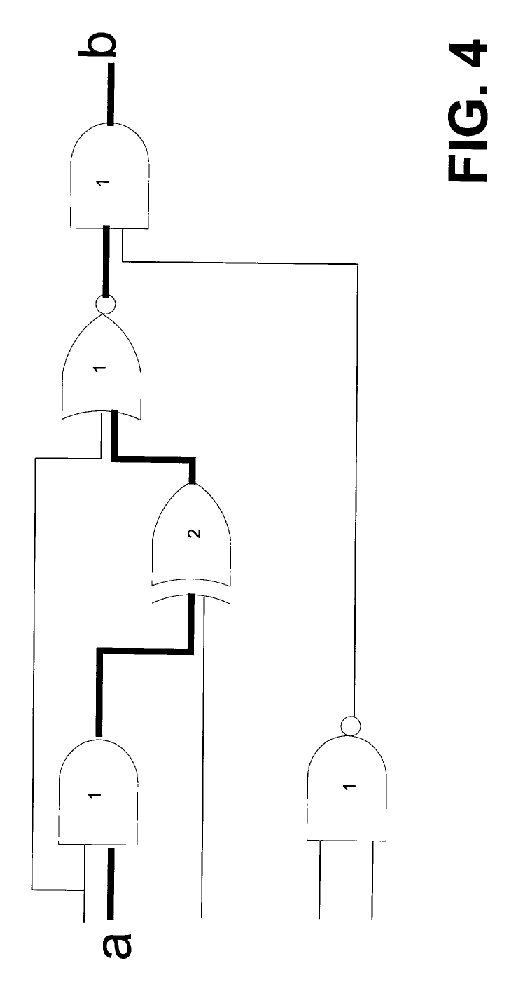

Initial constraints for each subdesign are obtained using system specification C (step 310). System specification C contains various constraints for the total circuit that will be designed according to design D. Constraints are typically defined in terms of ranges or minimum and maximum values for such variables as physical area or maximum delay of the circuit. Although many different types of constraints may be computed, most common is the maximum delay through a circuit path. FIG. 4 shows a basic circuit diagram. A “path” from input a to output b is defined to be a sequence of gates such that one of the inputs of the first gate in the sequence is connected to a and one of the outputs of the last gate in the sequence is connected to b. Path length is the sum of the gate delays along the path. For example, in the circuit shown in FIG. 4, the path length of a path from input a to output b as indicated by a heavier line may be 5 nanoseconds. When referring to the specification, the maximum delay desired by the circuit designer for a specific path is referred as the required time. Once the circuit is implemented, the actual delay time over a specific path is called the “arrival time.” The difference between the required time desired by the designer and the actual arrival time achieved in the final implementation of the circuit is referred to as the “slack.”

The following example is described using required times as the constraints for the circuit design. To obtain initial constraints for the required times for each subdesign, the required time for the total circuit specified by system specification C must be broken down into a set of constraints corresponding to each subdesign.

For example, assume overall design D is a simple chain of buffers that is divided into N subdesigns, each subdesign consisting of one buffer. A buffer has one input and one output and a logical function such that the output equals the input. The initial constraint for the required time of the ith subdesign is computed as the simple ratio, L₁*C/L₁ where L₁ is the path of the ith part of the chain and L is the path length of the whole chain.

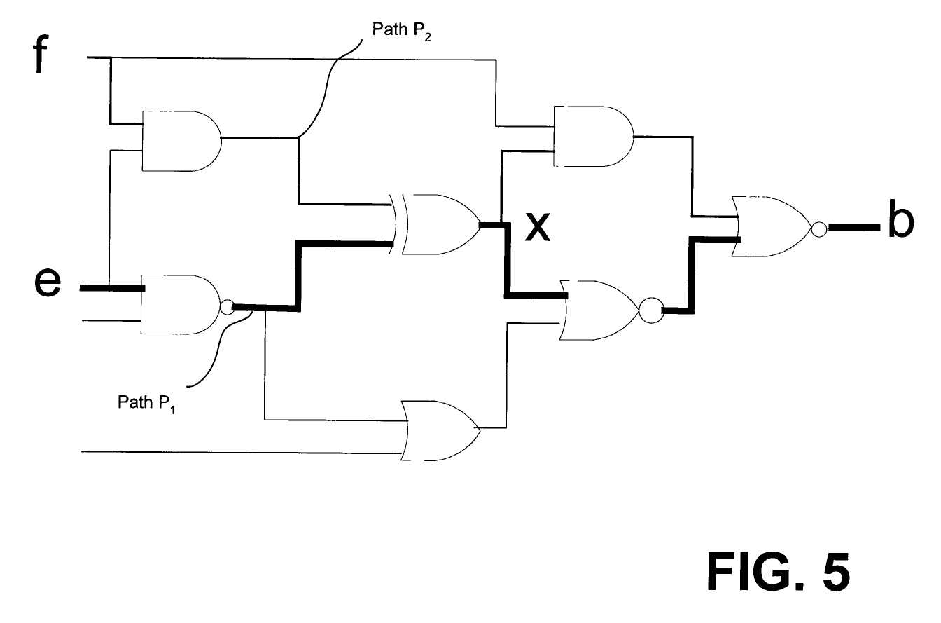

When the circuit comprises more than just a chain of buffers, the method of determining initial constraints for the required times of each subdesign becomes more complex. FIG. 5 illustrates a circuit with multiple paths through point x. In FIG. 5, path P₁ (indicated by a heavier line) starts at input e, passes through point x, and ends at output b. Path P₂ (indicated by a medium weight line) also passes through point x and ends at output b but begins at point f. The required time for output x over path P₁ is calculated as follows: Rₓ=Rₑ+(Lₑₓ/L_{eb})*(R_{b}−Rₑ), where R_{b} is the required time of output b, Rₑ is the required time of output e, L_{xb} is the path delay from x to b and L_{eb} is the path delay from e to b. The required time for output x is the maximum required time for x over all possible paths P passing through x and may be mathematically represented as follows:

Rₓ=max {Rₑ+(Lₑₓ/L_{eb})*(R_{b}−Rₑ)}

over all P

For each subdesign, the input arrival time is the output required time of the subdesign that would be the previous stage. The set of Rₓ for all subdesigns forms the set of initial constraints for the sub designs.

A constraint range is generated from each initial constraint according to a percentage of perturbation (step 320). The percentage of perturbation may be defined by the user or generated dynamically. In one embodiment of the present invention, the constraint ranges are perturbed proportional to the maximum delays of the corresponding subdesign. For example, the constraint corresponding to a candidate subdesign with a longer delay will produce a wider constraint range than a candidate subdesign with a shorter delay. Candidate subdesigns that already have short delays will be more difficult to optimize and therefore trial and error over a wide constraint range is inefficient.

If perturbation is calculated as a function of maximum delay, for example, the amount of perturbation applied to the constraints to obtain constraint ranges may be described using the following formula. Let Uₓ be a percentage range over which constraints at output x can vary. Then, the range of the required time for output X with initial required time Rₓ is given by [R1ₓ, R2ₓ, where:

R1=Rₓ−(L₁/(L₁+L₂))*Uₓ*Rₓ, and

R2=Rₓ+(L₂/(L₁+L₂))*Uₓ*Rₓ.

L₁ is the maximum delay of all paths in a subdesign whose output is X. L₂ is the maximum delay of all paths in a subdesign whose input is X. R1ₓ forms the lower limit of the constraint range, I, and R2x forms the upper limit of the constraint range, I.

The perturbation set for a subdesign with constraint set C₁=Rₓ₁, Rₓ₂, Rₓₙ, . . . is formed by selecting values from the set formed by the Cartesian product I₁×I₂ x . . . x Iₙ, where Iᵢ is the perturbation interval (R1ₓᵢ, R2ₓ₁) for the ith subdesign. The Cartesian product of sets A and B is defined as A×B={(a,b)|a∈A Λ b∈B}. The synthesis software may choose values throughout the constraint set Cᵢ according to any number of methods well understood in the art, such as using uniform or Gaussian distribution methods. In the uniform distribution method, for example, points are chosen that are uniformly distributed throughout the interval. In a Gaussian distribution method, the points are chosen according to a Gaussian distribution.

A synthesis job is created for each subdesign by associating each subdesign with its corresponding constraint range to form a synthesis job (step 330). Each synthesis job is dispatched to a processor (step 340). If there are more subdesign/constraint pairs to be dispatched (step 350), the process moves to the next subdesign (step 355) and continues from step 330. Once all of the constraints are distributed, the synthesis jobs are processed in parallel (step 360) to obtain a set of results R(C) (step 370). The set of results is stored in a data base (step 375) and a “best” result from the set is selected (step 380). In the timing constraint example, the “best” result would be the design that produces the shortest delay.

If the best result is determined to produce a circuit design that is within acceptable limitations (step 390), the process terminates. If the circuit design needs to be further refined, the best result may be used as a seed for another iteration of synthesis jobs (step 395). The best result may be, for example, the result that produced the fastest runtime or the circuit that most closely approximates the functional specification. The best result is then used as the constraint seed (step 310) and the process continued from step 320.

D. Conclusion

As described in detail above, methods and apparatus consistent with the present invention allow a user to design a circuit in parallel by distributing subdesigns of the overall design and constraints sets from a family of constraints sets over a network of computers. The foregoing description of an implementation of the invention has been presented for purposes of illustration and description. For example, the described implementation includes software but the present invention may be implemented as a combination of hardware and software or in hardware alone. The scope of the invention is therefore defined by the claims and their equivalents.

What is claimed is:

1. A method of generating a circuit comprising the steps of:
(a) receiving a circuit design;
(b) receiving an initial circuit constraint;
(c) generating a plurality of subdesigns based on the circuit design;
(d) generating a plurality of constraints based on the initial circuit constraint, each constraint corresponding to a subdesign;
(e) distributing each subdesign and corresponding constraint to one of a plurality of processors; and
(f) generating, in parallel, a plurality of candidate circuits based on the plurality of subdesigns and constraints.

2. The method of claim 1, comprising the step of:
(g) generating a plurality of constraint sets based on the plurality of constraints.

3. The method of claim 2, wherein the step of generating a plurality of constraint sets comprises the substeps of:
perturbing each of the plurality of constraints proportional to the maximum delay of the corresponding subdesign.

4. The method of claim 1, comprising the step of:
(h) selecting one of the plurality of candidate circuits to be the initial circuit constraint; and
(i) repeating steps (d) through (f).

5. The method of claim 1, wherein the step of generating a plurality of subdesigns comprises the substeps of:
generating one or more initial circuits based on the circuit design; and
generating a plurality of subdesigns based on the one or more initial circuits.

6. An apparatus for generating a circuit comprising:
a memory storing program instructions, and
a processor configured according to the program instructions to perform the steps of:
(a) receiving a circuit design;
(b) receiving an initial circuit constraint;
(c) generating a plurality of subdesigns based on the circuit design;
(d) generating a plurality of constraints based on the initial circuit constraint, each constraint corresponding to a subdesign;
(e) distributing each subdesign and corresponding constraint to one of a plurality of processors; and
(f) generating, in parallel, a plurality of candidate circuits based on the plurality of subdesigns and constraints.

7. The apparatus of claim 6, wherein the processor is configured to use program instructions to perform the step of:
(g) generating a plurality of constraint sets based on the plurality of constraints.

8. The apparatus of claim 7, wherein the step of generating a plurality of constraint sets comprises:
perturbing each of the plurality of constraints proportional to the maximum delay of the corresponding subdesign.

9. The apparatus of claim 6, wherein the processor is configured to use program instructions to perform the step of:
(h) selecting one of the plurality of candidate circuits to be the initial circuit constraint; and
(i) repeating steps (d) through (f).

10. The apparatus of claim 6, wherein the step of generating a plurality of subdesigns comprises the substeps of:
generating one or more initial circuits based on the circuit design; and
generating a plurality of subdesigns based on the one or more initial circuits.

11. A computer-usable medium having computer-readable code embodied therein for generating a circuit, the computer-usable medium comprising:
(a) a component configured to obtain a circuit design;
(b) a component configured to obtain an initial circuit constraint; /
(c) a component configured to generate a plurality of subdesigns based on the circuit design;
(d) a component configured to generate a plurality of constraints based on the initial circuit constraint, each constraint corresponding to a subdesign;
(e) a component configured to distribute each subdesign and corresponding constraint to one of a plurality of processors; and
(f) a component configured to generate, in parallel, a plurality of candidate circuits based on the plurality of subdesigns and constraints.

12. The medium of claim 11, comprising:
(g) a component configured to generate a plurality of constraint sets based on the plurality of constraints.

13. The medium of claim 12, wherein the a component configured to generate a plurality of constraint sets comprises:
a component configured to perturb each of the plurality of constraints proportional to the maximum delay of the corresponding subdesign.

14. The medium of claim 11, comprising:
(h) a component configured to select one of the plurality of candidate circuits to be the initial circuit constraint; and
(i) a component configured to repeat steps (d) through (f).

15. The medium of claim 11, wherein the step of generating a plurality of subdesigns comprises the substeps of:
generating one or more initial circuits based on the circuit design; and
generating a plurality of subdesigns based on the one or more initial circuits.

16. A system for generating a circuit comprising:
(a) means for receiving a circuit design;
(b) means for receiving an initial circuit constraint;
(c) means for generating a plurality of subdesigns based on the circuit design
(d) means for generating a plurality of constraints based on the initial circuit constraint, each constraint corresponding to a subdesign;
(e) means for distributing each subdesign and corresponding constraint to one of a plurality of processors; and
(f) means for generating, in parallel, a plurality of candidate circuits based on one of the plurality of subdesigns and constraints.
